(19) United States
(12) Patent Application Publication
(10) Pub. No.: US 2005/0209353 A1
(43) Pub. Date: Sep. 22, 2005

(54) Method for producing polyurethane foamed materials having an improved long-term stability

(76) Inventors: Martin Kreyenschmidt, Lohne (DE); Jahns Ekkehard, Weinheim (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/512,081

(22) PCT Filed: May 21, 2003
(86) PCT No.: PCT/EP03/05310

§ 371 Date: Nov. 8, 2004

(30) Foreign Application Priority Data
May 27, 2002 (DE) 10223617.8

(51) Int. Cl. C08J 9/00

(52) U.S. Cl. 521/155

(57) ABSTRACT

Polyurethane foams having improved long-term stability are prepared by reacting a) polyisocyanates with b) compounds having at least two hydrogen atoms reactive with isocyanate groups, in the presence of inhibitors, by a process in which the inhibitors are encapsulated in a substance which is inert under the conditions of the polyurethane preparation, in particular wax.

The present invention relates to polyurethanes, in particular polyurethane foams having improved long-term stability, and a process for their preparation. The present invention furthermore relates to the use of inhibitors which are encapsulated in wax, for improving the long-term stability of polyurethanes, in particular of flexible polyurethane foams.

In this application, inhibitors are understood as meaning compounds which are intended to counteract cleavage of the polyurethanes formed and which are intended to prevent aromatic amines which can form during such a cleavage from migrating out of the foam.

Polyurethane foams have long been known and are widely described in the literature. They are usually prepared by reacting isocyanates with compounds having at least two hydrogen atoms reactive with isocyanate groups.

As in the case of other plastics, polyurethanes are subject to aging processes which generally lead to a deterioration in the performance characteristics with increasing time. Substantial aging influences are, for example, hydrolysis, photooxidation and thermal oxidation, which lead to the cleavage of bonds in the polymer chains. In the case of polyurethanes, especially the action of moisture, in particular in combination with elevated temperatures, results in hydrolytic cleavage of the urethane and urea bonds.

This cleavage not only manifests itself in a significant deterioration in the performance characteristics but also leads to the formation of amines, in particular aromatic amines, such as toluenediamine (TDA) and diphenylmethanediamine (MDA), and aliphatic amines, such as hexamethylenediamine (HDA) and isophoronediamine (IPDI):

A substantial parameter which influences the formation of amines is the type and amount of the catalyst used for the urethane reaction. It has been possible to show that these catalysts also catalyze the hydrolytic cleavage of the urethane bond to a considerable extent. Furthermore, it has been found that the hydrolytic cleavage is also influenced by whether the catalysts used for the urethane formation can migrate out of the polyurethane or remain in the system. In order to reduce the emission of the polyurethanes, catalysts which can be incorporated have been recently used with preference. However, this has an adverse effect on the hydrolysis stability and aging stability of the polyurethanes.

It is known that the hydrolysis stability and aging stability of the polyurethane can be improved by adding inhibitors or coreactants for the degradation products. According to WO 00/66643, inhibitors or coreactants used are α,β-unsaturated compounds, carboxylic acids, carboxylic acid derivatives, ketones or aldehydes.

Useful inhibitors include, according to DE-A-199 28 687, lactones, lactams and/or cyclic esters, according to DE-A-199 28 688, cyclic sulfonic esters and/or sulfones, according to DE-A-199 28 675, salts of metals of subgroups I, II and/or VIII, and, according to DE-A-199 28 689, organic cyclic compounds having a molecular weight of from 200 to 3 000 g/mol.

In the polyurethanes, said compounds produce both blocking of the amine urethanization catalysts and complexing of amines which were formed in the hydrolytic cleavage of the urethane bonds.

The inhibitors are generally added in pure form to the polyol component or the isocyanate component before the reaction. The disadvantage here is that they can react with the amine catalysts or with the amines used as chain extenders before or during the preparation of the polyurethanes. This can lead to defects in the network structure of the polyurethanes and/or to a slowing down of the reaction. This results in excessively long molding times of the products and hence a loss of efficiency.

It is an object of the present invention to provide polyurethanes which have high hydrolysis stability and in which the inhibitors do not display their activity until after the preparation of the polyurethanes.

We have found that this object is achieved, surprisingly, by including the inhibitors in inert compounds.

The present invention therefore relates to a process for the preparation of polyurethane foams having improved long-term stability by reacting
a) polyisocyanates with
b) compounds having at least two hydrogen atoms reactive with isocyanate groups, in the presence of inhibitors,
   wherein the inhibitors are included in a substance which is inert under the conditions of the polyurethane preparation, in particular wax.
   The present invention also relates to the polyurethanes prepared by this process, in particular flexible polyurethane foams.
   The present invention furthermore relates to inhibitors for polyurethanes, which are included in a substance which is inert under the conditions of the polyurethane preparation, in particular wax.

In the context of this invention, wax is understood as meaning compounds whose melting point is in general from 20 to 150° C., preferably from 30 to 130° C., particularly preferably from 40 to 120° C. Furthermore, the waxes of the present invention are generally kneadable or firm to brittle and hard, but not glassy, in the solid state. Even slightly above the melting point, the waxes of the present invention generally have a relatively low viscosity and are preferably not stringy.

The melting point of the waxes should preferably be chosen so that they melt during the polyurethane reaction. In particular, the melting point should be such that the waxes melt only toward the end of the reaction, since otherwise a reaction of the inhibitors with the other reaction components cannot be completely ruled out.

The term waxes includes natural waxes, chemically modified waxes and synthetic waxes. Natural waxes include vegetable waxes, for example Montan wax, animal waxes, such as beeswax, mineral waxes and petrochemical waxes, such as petrolatum, paraffin wax and microwax. Chemically modified waxes include, for example, hard waxes, such as Montan ester waxes. Synthetic waxes include alkane waxes, such as wax alcohols, in particular relatively high molecular weight water-insoluble fatty alcohols of, preferably, more than 12 carbon atoms, for example lignoceryl alcohol, ceryl alcohol, myricyl alcohol, mellisyl alcohol and polyalkylene oxides, such as polyethylene oxide, poly-THF, polyvinyl ether waxes, polyolefin waxes and oxidized polyolefin waxes. Furthermore, the term waxes includes relatively high molecular weight fatty acids, preferably of at least 9 carbon atoms, for example behenic acid, tetracosanoic acid and cerotinoic acid, which, if required, may be esterified with alcohols, and high molecular weight polyesters having a molecular weight of >1 000, preferably >1 500, g/mol, which are obtainable by reacting di- or polycarboxylic acids of 2 to 20 carbon atoms with di- or polyalcohols of 2 to 30 carbon atoms, it being possible for the corresponding acids and alcohols to contain aliphatic and/or aromatic structural units. Mixtures of the abovementioned waxes may also be used.

The waxes are in general polymeric substances. The polar groups may be present at the end and/or inside the polymer. Examples of polar groups are acid, amino, imino, amido, ether, ester, acetate, keto, aldehyde and alcohol groups.

The waxes used in the present invention have a heat of fusion of from 50 to 250, preferably from 100 to 200, in particular from 120 to 190, joules/gram. The heats of fusion are measured according to ISO 11357-3, by the DSC method (differential scanning calorimetry).

A further aspect of the present invention is that the waxes used preferably additionally contain one or more polar groups so that the compatibility between wax and inhibitor is increased. Polar groups are groups which have an electronegativity differing from that of a pure hydrocarbon group. In general, oxygen atoms, nitrogen atoms, sulfur atoms and possibly halogen atoms serve as a basis for polar groups. Pure alkane or paraffin waxes are not preferred for the novel process since they do not contain any polar groups in the context of the present invention.

In a preferred embodiment, polar polyolefin waxes are used. Polyolefins used are polyethylene, polypropylene, polybut-1-ene and copolymers of ethylene with from 0 to 20 mol % of propene, 1-butene, 1-pentene, 1-hexene, 1-octene, 1-decene or 1-undecene. Polyethylene wax comprising from 0 to 10 mol % of propene, 1-butene, 1-pentene or 1-hexene is preferred. The average molecular weight M_{w} of these polyolefin waxes is from 500 to 20 000, preferably from 2 000 to 15 000, particularly preferably from 3 000 to 10 000, g/mol.

Polar groups can generally be introduced into a wax by different process steps. A preferred method is to degrade the wax partially, for example by means of atmospheric oxygen or peroxide compounds, resulting in oxidized polyolefin waxes. Peroxide compounds used may be, for example, hydrogen peroxide (H₂O₂) or dialkyl peroxides. By means of partial degradation methods, hydroxyl groups and carboxyl groups are introduced as polar groups into the macromolecules.

Preferably used oxidized polyolefin waxes are those which have an acid number of not more than 50, preferably from 10 to less than 50.

A further preferred method comprises using polar comonomers, such as acrylic acid, methacrylic acid, acrylic esters, methacrylic esters or vinyl acetate, which optionally may be hydrolyzed, resulting in copolymer polyolefin waxes.

Ethylene/vinyl acetate waxes having an Mw of from 2 000 to 15 000, in particular from 3 000 to 10 000, g/mol and a vinyl acetate content of from 0.1 to 25, particularly preferably from 1 to 15, % by weight, based on the total weight of the copolymer, are preferably used.

Furthermore, ethylene/acrylic acid waxes having an M_{w} of from 2 000 to 15 000, in particular from 3 000 to 10 000, g/mol and an acrylic acid content of from 0.1 to 20, particularly preferably from 1 to 15, % by weight, based on the total weight of the copolymer, are preferably used.

In a further preferred embodiment, ethylene/acrylic acid/acrylate terpolymer waxes are used. These have an acrylic acid content of from 0.1 to 20, preferably from 1 to 5, % by weight and an acrylate content of from 0.1 to 40, preferably from 1 to 20, % by weight, with the proviso that the total content of acrylate and acrylic acid is less than 50, preferably less than 40, % by weight, based on the total weight of the terpolymer.

In a particularly preferred embodiment, polyether waxes are used. These generally have a molecular weight M_{w} of from 10 000 to 50 000, preferably from 15 000 to 35 000, g/mol. Polyvinyl ether waxes, for example polyoctadecyl vinyl ether or corresponding polyethers which have a C16, C17, C19, C20, C21 or C22 radical instead of an octadecyl radical, are particularly suitable.

In a further preferred embodiment, Montan waxes and Montan ester waxes are used. These are based on long-chain fatty acids, in general composed of hydrocarbon chains of 20 to 40, preferably 30 to 36, carbon atoms.

The term polyurethanes includes adducts which generally contain urethane, allophanate, urea, biuret, uretdione, amide, isocyanurate, carbodiimide and/or uretonimine groups. Urethane and urea groups are preferred.

The inhibitors used may be the known compounds customary for this purpose. Examples of these are α,β-unsaturated compounds, carboxylic acids, carboxylic acid derivatives, ketones or aldehydes, lactones, lactams and/or cyclic ethers, esters, sulfonic esters, cyclic sulfonic esters and/or sulfones, salts of metals of subgroups I, II and/or VIII and organic cyclic compounds as stated above, and furthermore organic and inorganic acids and their derivatives, provided that they are capable of being converted into an acid during the hydrolysis process.

The novel polyurethanes may be compact or cellular. In a preferred embodiment, the polyurethanes are flexible, rigid, semirigid or integral foams, in particular flexible polyurethane foams for use in furniture, carpet foam backings and mattresses as well as automobile seats.

For the preparation of the inhibitors used according to the invention and encapsulated in wax, inhibitors are in general dissolved or suspended in heated, liquid wax. If required, a solubilizer which results in better dissolution of the inhibitors in the wax may be added. The mixture of liquid wax and inhibitors is then preferably cooled and dispersed in a polar liquid. If required, a dispersant which leads to advantageous dispersing may be added to the melt before this step. In a preferred embodiment, the dispersing is effected by a procedure in which the encapsulated inhibitors used according to the invention are present in particulate form, comprising particles having a median particle diameter of from 10 to 800 μm, preferably from more than 100 to less than 600 μm, more preferably from 110 to 500 μm, particularly preferably from 120 to 300 μm.

The median particle diameter, which is also referred to as d₅₀ value of the integral mass distribution, is defined in the context of this invention as the particle diameter at which 50% by weight of the particles have a smaller diameter than the diameter which corresponds to the d₅₀ value. 50% by weight of the particles then have a larger diameter than the d₅₀ value. The particle diameter is determined by measurement using an optical microscope, sphere-like particles being estimated as the equivalent sphere diameter.

A suitable polar liquid is in general any liquid in which the wax is insoluble. Water or a compound having at least two hydrogen atoms reactive toward isocyanate groups is preferably used. A preferably used component here is a polyol, in particular a polyetherol, particularly preferably a polyol which is used in a preparation of polyurethanes. The use of this polyol is advantageous since no foreign substance is introduced into the system thereby and, in the case of cellular products, possible destabilization of the foam by foreign substances can be avoided.

In general, compounds which, for example, can form hydrogen bridge bonds to the inhibitors and thus improve the solubility can be used as solubilizers. For example, polar polymers, e.g. polyethylene oxide or polypropylene oxide or copolyethers of ethylene oxide and propylene oxide, are suitable. The solubilizer is usually used in an amount of from 0.1 to 10, preferably from 0.5 to 5, % by weight, based on the weight of wax and inhibitor.

Suitable dispersants are in general amphiphilic molecules which have a hydrophobic moiety compatible with the wax and a hydrophilic moiety compatible with the polar liquid. For example, stearic acid can be used for this purpose. The dispersant is usually used in an amount of from 0.1 to 20, preferably from 1 to 10, % by weight, based on the weight of the wax and inhibitor.

In a further embodiment for the preparation of the inhibitors used according to the invention, the liquid mixture of inhibitors and heated wax can be brought into a suitable, particulate form directly by atomization in an air stream, preferably a cold air stream, so that a preferably granular powder is obtained. In terms of process engineering, an apparatus which is similar to a spray dryer but which is operated with a cold air current is suitable. Furthermore, the inhibitor dispersed in a polar liquid may also be freeze-dried. For this purpose, the dispersion of the inhibitor is first frozen and the dispersant is removed under reduced pressure.

A dry powder is obtained. Both processes preferably lead to powders which have median particle diameters of from 10 to 800 μm, preferably from more than 100 to less than 600 μm, more preferably from 110 to 500 μm, particularly preferably from 120 to 300 μm.

The inhibitors used according to the invention can advantageously be used in polyurethanes, in particular of flexible polyurethane foams.

The inhibitors embedded in the wax do not influence the cream times and the reaction behavior of the polyurethane system. However, heat is liberated in the course of the reaction and the wax melts above a defined temperature and releases the inhibitor. Depending on the melting point of the wax used, the liberation of the inhibitor can be achieved at a different point in time on the reaction coordinate. The inhibitors are preferably not released until toward the end of the reaction, so that an adverse effect on the catalysis of the polyurethane formation can be ruled out. After the melting of the wax, the inhibitors immediately display their full activity.

It is also possible to encapsulate only a part of the inhibitor in wax and to use another part in unencapsulated form. This process variant is preferably used if a combination of a plurality of inhibitors is employed. It has proven advantageous to encapsulate only the inhibitors which intervene particularly strongly in the catalysis of the polyurethane reaction.

A particular advantage of the novel process is that inhibitors which react with the constituents of the polyol component and can thus have a particularly adverse effect on the network structure of the polyurethanes can also be added to the polyol component.

In a particular embodiment of the novel process, the inhibitors are embedded in substances which are inert under the conditions of the polyurethane preparation and which liberate the inhibitors only under hydrolysis conditions. This embodiment has the advantage that the inhibitors are liberated only when they are intended to display their activity in the polyurethane. This avoids the situation where a part of the inhibitors used migrates out of the polyurethane even before the start of the hydrolysis and is thus lost as inhibitors.

The inhibitors are generally used in the conventional amounts. They are preferably used in an amount of from 0.1 to 20, in particular from 0.5 to 10, % by weight, based on the weight of the polyurethane.

Regarding the other starting materials which can be used for the novel process, the following may be stated specifically:

The polyisocyanates a) used include the aliphatic, cycloaliphatic and aromatic isocyanates known from the prior art. Examples are diphenylmethane diisocyanate, in particular diphenylmethane 4,4′-diisocyanate, the mixtures of monomeric diphenylmethane diisocyanates and more multinuclear homologs of diphenylmethane diisocyanate (polymer MDI), tetramethylene diisocyanate, tetramethylene diisocyanate trimers, hexamethylene diisocyanate, hexamethylene diisocyanate trimers, isophorone diisocyanate trimer, methylenebis(cyclohexyl) 4,4′-diisocyanate, xylylene diisocyanate, tetramethylxylylene diisocyanate, dodecyl diisocyanate, lysine alkyl ester diisocyanate, where alkyl is C₁ to C₁₀, 2,2,4- or 2,4,4-trimethylhexamethylene 1,6-diisocyanate, 1,4-diisocyanatocyclohexane, 1,3- or 1,4-bis(isocyanatomethyl)cyclohexane or 4-isocyanatomethyloctamethylene 1,8-diisocyanate, tolylene diisocyanate ((TDI), such as mixtures of tolylene 2,6- and 2,4-diisocyanate, diphenylmethane 2,4′-diisocyanate (2,4′-MDI), triisocyanatotoluene, isophorone diisocyanate (IPDI), 2-butyl-2-ethylpentamethylene diisocyanate, 2-isocyanatopropylcyclohexyl isocyanate, 3(4)-isocyanatomethyl-1-methylcyclohexyl isocyanate, 1,4-diisocyanato-4-methylpentane, methylenebis(cyclohexyl) 2,4′-diisocyanate and 4-methylcyclohexane 1,3-diisocyanate (H-TDI).

Diphenylmethane diisocyanate, in particular diphenylmethane 4,4′-diisocyanate, and tolylene diisocyanate are preferably used as polyisocyanates in the preparation of the flexible polyurethane foams. Polyisocyanates used may also be mixtures of the abovementioned isocyanates.

Suitable compounds b) having at least two hydrogen atoms reactive toward isocyanate groups are compounds which carry two or more reactive groups selected from OH groups, SH groups, NH groups, NH₂ groups and CH-acidic groups, e.g. β-diketo groups, in the molecule.

Those having a functionality of from 2 to 8, preferably from 2 to 6, and a molecular weight of from 300 to 8 000, preferably from 400 to 4 000, are expediently used. For example, polyetherpolyamines and/or preferably polyols selected from the group consisting of the polyetherpolyols, polyesterpolyols, polythioetherpolyols, polyesteramides, hydroxyl-containing polyacetals and hydroxyl-containing aliphatic polycarbonates or mixtures of at least two of said polyols have proven useful. Polyesterpolyols and/or polyetherpolyols are preferably used. The hydroxyl number of the polyhydroxy compounds is as a rule from 10 to 1 000, preferably from 20 to 300.

In a preferred embodiment, the compounds b) having at least two hydrogen atoms reactive toward isocyanate groups are polyetherpolyols. They are prepared by known processes, for example by anionic polymerization with alkali metal hydroxides or alkali metal alcoholates as catalysts and with the addition of at least one initiator which contains 2 or 3 reactive bonded hydrogen atoms per molecule, from one or more alkylene oxides having from 2 to 4 carbon atoms in the alkylene radical. Suitable alkylene oxides are, for example, tetrahydrofuran, 1,3-propylene oxide, 1,2- and 2,3-butylene oxide and preferably ethylene oxide and 1,2-propylene oxide. The alkylene oxides can be used individually, alternately in succession or as mixtures. Mixtures of 1,2-propylene oxide and ethylene oxide are preferred, the ethylene oxide being used in amounts of from 10 to 50% as a terminal ethylene oxide block (EO-cap), so that the resulting polyols have more than 70% of terminal primary OH groups.

A suitable initiator molecule is water or a dihydric or trihydric alcohol, such as ethylene glycol, 1,2- and 1,3-propanediol, diethylene glycol, dipropylene glycol, 1,4-butanediol, glycerol, trimethylolpropane, etc. The polyetherpolyols, preferably polyoxypropylenepolyoxyethylenepolyols, have a functionality of from 2 to 3 and molecular weights of from 1 000 to 8 000, preferably from 2 000 to 7 000.

Other suitable polyetherpolyols are polymer-modified polyetherpolyols, preferably graft polyetherpolyols, in particular those based on styrene and/or acrylonitrile, which are prepared by in situ polymerization of acrylonitrile, styrene or preferably mixtures of styrene and acrylonitrile.

Polyesterpolyols are furthermore suitable. These can be prepared, for example, from organic dicarboxylic acids of 2 to 12 carbon atoms, preferably aliphatic dicarboxylic acids of 4 to 6 carbon atoms, and polyhydric alcohols, preferably diols, of 2 to 12, preferably 2 to 6, carbon atoms. Examples of suitable dicarboxylic acids are succinic acid, glutaric acid, adipic acid, suberic acid, azelaic acid, sebacic acid, decanedicarboxylic acid, maleic acid, fumaric acid, phthalic acid, isophthalic acid and terephthalic acid. The dicarboxylic acids may be used either individually or as a mixture with one another. Instead of the free dicarboxylic acids, it is also possible to use the corresponding dicarboxylic acid derivatives, such as dicarboxylates of alcohols of 1 to 4 carbon atoms or dicarboxylic anhydrides. Dicarboxylic acid mixtures comprising succinic, glutaric and adipic acid and aromatic dicarboxylic acids are preferably used. Examples of dihydric and polyhydric alcohols, in articular diols, are ethanediol, diethylene glycol, 1,2- and 1,3-propanediol, dipropylene glycol, 1,4-butanediol, 1,5-pentanediol, 1,6-hexanediol, 1,10-decanediol, glycerol and trimethylolpropane, and furthermore dialcohols which contain aromatic or aliphatic ring systems, e.g. 1,4-bisdihydroxymethylbenzene or 1,4-bisdihydroxyethylbenzene. Ethanediol, diethylene glycol, 1,4-butanediol, 1,5-pentanediol and 1,6-hexanediol are preferably used. Polyesterpolyols obtained from lactones, e.g. ε-caprolactone, or hydroxycarboxylic acids, e.g. ω-hydroxycaproic acid, may furthermore be used. Mixed systems which contain both polyesterols and polyetherols can likewise be used.

The compounds b) having at least two hydrogen atoms reactive toward isocyanate groups also include the chain extenders and crosslinking agents. These include low molecular weight, polyhydric alcohols, preferably diols and/or triols, having molecular weights of less than 400, preferably from 60 to 300, particularly preferably from 60 to 200, daltons. For example, aliphatic, cycloaliphatic and/or araliphatic diols, such as alkanediols of 2 to 14, preferably 2 to 6, carbon atoms and/or dialkylene glycols of 4 to 8, preferably 4 to 6, carbon atoms, e.g. ethylene glycol, 1,3-propanediol, 1,10-decanediol, o-, m- and p-dihydroxycyclohexane, diethylene glycol, triethylene glycol, dipropylene glycol, tripropylene glycol and preferably 1,3-butanediol, 1,4-butanediol, 1,6-hexanediol and bis(2-hydroxyethyl)hydroquinone, 1,5-pentanediol and 1,3-pentanediol and mixtures of different diols and, as polyhydric alcohols, for example triols, such as 1,2,4- and 1,3,5-trihydroxycyclohexane, trimethylolethane, glycerol and trimethylolpropane are suitable. Diols and mixtures thereof are preferably used.

The novel process is generally carried out in the presence of catalysts. For example, organic amines, alone or as mixtures containing at least two amines, are suitable. Catalysts used may furthermore be conventional organic metal compounds, preferably organic tin compounds, such as tin(II) salts of organic carboxylic acids, tin(IV) salts of organic carboxylic acids, e.g. dibutyltin diacetate, dibutyltin dilaurate, dibutyltin maleate and dioctyltin diacetate. Potassium salts of carboxylic acids, for example potassium acetate, and metal catalysts comprising bismuth, iron or zirconium compounds, e.g. iron acetylacetonate, may furthermore be used.

Tertiary aliphatic and/or cycloaliphatic amines may preferably be contained in the mixtures, particularly preferably triethylenediamine.

Mixtures which contain both amine-based catalysts and catalysts based on organic metal compounds may furthermore be used as the catalyst.

From 0.01 to 15, preferably from 0.1 to 8, particularly preferably from 0.5 to 4, % by weight, based on the weight of the components a) and b), of catalyst are generally used.

The use of blowing agents is necessary for the preparation of polyurethane foams. A preferably used blowing agent is water. Since, owing to the preparation and/or chemical composition, the components b) may contain water, separate addition of water to the component b) or to the reaction mixture is not necessary in some cases. If water additionally has to be introduced into the polyurethane formulation for achieving the desired density, said water is usually used in amounts of from 0.05 to 4.0, preferably from 0.1 to 3.0, in particular from 0.3 to 2.5, % by weight, based on the weight of the components a) and b).

Instead of water or preferably in combination with water, low-boiling liquids which vaporize under the influence of the exothermic polyaddition reaction and advantageously have a boiling point at atmospheric pressure of from −40 to 120° C., preferably from 10 to 90° C., or gases may also be used as blowing agents. Among the liquids which are suitable as blowing agent d) and are inert with respect to NCO groups, alkanes, cycloalkanes or mixtures having a boiling point of from −40 to 50° C. at atmospheric pressure, comprising alkanes and cycloalkanes, are preferably used.

The liquids of the abovementioned type and gases which are suitable as blowing agent can be selected, for example, from the group consisting of the alkanes, e.g. propane, n-butane, isobutane, n-pentane and isopentane and preferably the technical-grade pentane mixtures, cycloalkanes and cycloalkenes, e.g. cyclobutane, cyclopentene, cyclohexene and preferably cyclopentane and/or cyclohexane, and gases, e.g. nitrogen, carbon monoxide and noble gases, such as helium, neon and krypton.

Other suitable blowing agents are salts which undergo thermal decomposition, e.g. ammonium bicarbonate and/or ammonium carbamate, or compounds which form such salts in situ, e.g. aqueous ammonia and/or amines and carbon dioxide, and ammonium salts of organic carboxylic acids, such as the monoammonium salts of malonic acid, boric acid, formic acid or acetic acid. HFC-245fa® (from Honeywell) and HFC365mfc® (from Solvay) may also be used.

If required, assistants and additives may be added during the novel process for the preparation of polyurethanes.

Examples of assistants and/or additives are surface-active substances, foam stabilizers, cell regulators, external and internal lubricants, fillers and reinforcing materials, for example glass fibers, dyes, pigments, flameproofing agents, hydrolysis stabilizers, antioxidants, abrasion improvers and fungistatic and bacteriostatic substances.

Further information on the starting materials used can be found, for example, in Kunststoffhandbuch, Volume 7, Polyurethane, edited by Günter Oertel, Carl-Hanser-Verlag, Munich, 3rd edition, 1993.

For the preparation of the polyurethanes, polyisocyanates a) are reacted with compounds b) having at least two hydrogen atoms reactive toward isocyanate, in amounts such that the ratio of the number of equivalents of NCO groups of the polyisocyanates a) to the sum of the reactive hydrogen atoms of the components b) is from 1:0.5 to 1:3.50 (corresponding to an isocyanate index of from 50 to 350), preferably from 1:0.60 to 1:2.30, particularly preferably from 1:0.65 to 1:1.7.

The polyurethanes are usually prepared by the known one-shot process or the likewise known prepolymer process.

In industry, it is customary to combine the compounds b) having at least two hydrogen atoms reactive toward isocyanate, blowing agent, catalysts and assistants and/or additives to give a polyol component and to react them in this form with the polyisocyanates a).

The starting components are usually mixed at from 0 to 100° C., preferably from 15 to 70° C., and reacted, for example, in a mold. The mixing can be carried out, for example, mechanically by means of the low pressure technique or the high pressure technique or by other mixing methods which are used in conventional PU processing apparatuses.

The examples which follow illustrate the invention.

### EXAMPLES

### Preparation of the Foams

97 parts by weight of a polyetheralcohol having a hydroxyl number of 28 mg KOH/g, a functionality of 2.3 and a weight ratio of ethylene oxide to propylene oxide in the chain of 14/86, 3 parts by weight of a polyetheralcohol having a hydroxyl number of 42 mg KOH/g, a functionality of 3 and a weight ratio of ethylene oxide to propylene oxide in the chain of 30/70, 3.31 parts by weight of water, 0.8 part by weight of aminopropylimidazole, 0.6 part by weight of dimethylaminodiglycol, 0.5 part by weight of the foam stabilizer Tegostab® B8631 and in each case 1 part by weight of the hydrolysis stabilizer stated in table 1 were mixed to give a polyol component. This was reacted with an isocyanate component consisting of 50% by weight of polymer MDI and 50% by weight of dinuclear MDI. The materials were foamed at a polyol/isocyanate component mixing ratio of 100:48 (corresponding to an index of 90).

Cushions having a volume of 16 1 and a cushion density of 50 g/l were produced in a standard test mold. The corresponding test specimens for the aging experiments were cut from such a cushion.

In addition, a sample without additive was foamed, this being referred to as comparative example 1 in table 1. 1 part by weight of unencapsulated adipic acid was used in comparative example 2, 2 parts by weight of unencapsulated dimethylpropionic acid were used in comparative example 3, 1 part by weight of unencapsulated maleic anhydride was used in comparative example 4, 2.5 parts by weight of adipic acid in wax were used in example 1, 3.5 parts by weight of dimethylpropionic acid in wax were used in example 2 and 2.5 parts by weight of maleic anhydride in wax were used in example 3.

The systems were foamed immediately after mixing and after a storage time of 10 days.

For the foams obtained, the values shown in table 1 were determined immediately after preparation and after storage for three days at 90° C. and 90% relative humidity.

As is evident, the use of unencapsulated inhibitors results in a substantial deterioration in the reaction parameters in the preparation of the foams. In the case of the encapsulated inhibitors, this influence is noticeably suppressed without there being any deterioration in the mechanical values after storage under humid and warm conditions.

TABLE 1

| | Comparative | Comparative | Comparative | Comparative | | | |
|---|---|---|---|---|---|---|---|
| Example | Example 1 | Example 2 | Example 3 | Example 4 | Example 1 | Example 2 | Example 3 |
| Compression set* | 4.1/15.6 | 4.3/6.4 | 5.7/8.9 | 3.6/5.6 | 4.2/6.1 | 5.3/7.9 | 3.4/5.2 |
| Resilience (%)* | 68.5/49.3 | 69.3/62.2 | 68.2/62.3 | 69.7/64.3 | 70.5/64.1 | 69.4/63.3 | 70.2/65.9 |
| Compressive | 5.1/3.8 | 5.4/4.7 | 6.0/4.7 | 5.1/4.9 | 5.6/4.9 | 4.9/5.9 | 5.2/4.8 |
| strength 40%* | | | | | | | |
| Tensile strength | 95/59 | 94/101 | 87/73 | 88/71 | 90/96 | 96/89 | 93/82 |
| (kPa)* | | | | | | | |
| Elongation (%)* | 96/105 | 94/95 | 75/79 | 84/79 | 94/95 | 95/73 | 94/83 |
| Cream time (sec) | 13 | 23 | 25 | 19 | 14 | 14 | 14 |
| Rise time (sec) | 80 | 145 | 165 | 150 | 85 | 90 | 90 |
| Fiber time (sec) | 120 | 170 | 180 | 200 | 125 | 130 | 140 |
| Cream time** | 13 | 32 | 30 | 25 | 17 | 15 | 16 |
| (sec) | | | | | | | |
| Rise time** (sec) | 82 | 186 | 180 | 240 | 95 | 95 | 100 |
| Fiber time** | 122 | 240 | 215 | 350 | 140 | 135 | 160 |
| (sec) | | | | | | | |

*Immediately after foaming/after storage under humid and warm conditions
**After storage for 10 days

1. A process for the preparation of polyurethane foams having improved long-term stability by reacting
a) polyisocyanates with
b) compounds having at least two hydrogen atoms reactive with isocyanate groups, in the presence of inhibitors in an amount of from 01. to 20% by weight, based on the weight of the polyurethane,
wherein the inhibitors are embedded in a substance which is inert under the conditions of the polyurethane preparation.

2. A process as claimed in claim 1, wherein the inhibitors are embedded in a wax.

3. A process as claimed in claim 1, wherein the inert substances have a melting point such that they melt during the reaction which results in the polyurethane.

4. A process as claimed in claim 1, wherein the inert substances have a heat of fusion of from 50 to 250 joules/gram.

5. A process as claimed in claim 1, wherein the melting point of the inert substances is from 20 to 150° C.

6. A process as claimed in claim 2, wherein the wax contains one or more polar groups.

7. A process as claimed in claim 1, wherein the inhibitors are selected from the group consisting of α,β-unsaturated compounds, carboxylic acids, carboxylic acid derivatives, ketones aldehydes, lactones, lactams, cyclic ethers, esters, sulfonic acids, cyclic sulfonic esters, sulfones, salts of metals of subgroups I, II and VIII organic cyclic compounds, inorganic acids, organic acids, acid derivatives which can liberate acids in a hydrolysis process and mixtures thereof.

8. A process as claimed in claim 1, wherein the encapsulated inhibitors are present in particulate form.

9. A process as claimed in claim 8, wherein the particles have a median particle diameter of from 20 to 800 μm.

10. A polyurethane which can be prepared by a process as claimed in claim 1.
